(19) United States
(12) Patent Application Publication
(10) Pub. No.: US 2013/0127940 A1
(43) Pub. Date: May 23, 2013

(54) Liquid Ejecting Apparatus

(71) Applicant: Seiko Epson Corporation, Tokyo (JP)

(72) Inventor: Kohei Fujikawa, Nagano-ken (JP)

(73) Assignee: Seiko Epson Corporation, Tokyo (JP)

(21) Appl. No.: 13/669,885

(22) Filed: Nov. 6, 2012

(30) Foreign Application Priority Data
Nov. 18, 2011 (JP) 2011-252350

(51) Int. Cl. B41J 29/38

(52) U.S. Cl. 347/14

(57) ABSTRACT

A printer includes a displacement sensor that detects a change in the relative positions of an ink cartridge and a recording head. A printer controller performs an operation for restoring a meniscus in a nozzle if the change in the relative positions detected by the displacement sensor exceeds a threshold.

### CROSS-REFERENCE TO RELATED APPLICATION

The entire disclosure of Japanese Patent Application No. 2011-252350, filed Nov. 18, 2011 is expressly incorporated by reference herein.

### BACKGROUND

1. Technical Field

The present invention relates to a liquid ejecting apparatus such as an ink jet recording apparatus. In particular, the invention relates to a liquid ejecting apparatus including a liquid ejecting head that introduces a liquid stored in a liquid storage member into a pressure chamber and ejects the liquid in the pressure chamber from a nozzle by driving a pressure generating unit.

2. Related Art

Liquid ejecting apparatuses include liquid ejecting heads and eject various liquids from the ejecting heads. Examples of liquid ejecting apparatuses include image recording apparatuses such as ink jet printers and ink jet plotters. In recent years, liquid ejecting apparatuses have been used as various manufacturing apparatuses because they can make a very small amount of liquid land accurately at a predetermined position. For example, liquid ejecting apparatuses are used as display manufacturing apparatuses for manufacturing a color filter of a liquid crystal display or the like; electrode forming apparatuses for forming electrodes of an organic electro-luminescence (EL) display, a field emission display (FED), or the like; and chip manufacturing apparatuses for manufacturing a biochip. Image recording apparatuses have a recording head that ejects a liquid ink. Display manufacturing apparatuses have a colorant ejecting head that ejects solutions of red (R), green (G), and blue (B) colorants. Electrode forming apparatuses have an electrode material ejecting head that ejects a liquid electrode material. Chip manufacturing apparatuses have a bioorganic substance ejecting head that ejects a solution of a bioorganic substance.

Such liquid ejecting heads using a cartridge-type liquid storage member have been developed, because they are easy to distribute and easy to handle. For example, ink jet printers (hereinafter simply referred to as “printers”) that use an ink cartridge containing a liquid ink are widely used. With this structure, when an ink cartridge is attached to a recording head, which is an example of a liquid ejecting head, an ink introduction needle of the recording head is inserted into the ink cartridge. As a result, ink in the ink cartridge is introduced into the recording head through an ink introduction hole (liquid introduction hole) formed in a tip portion of the ink introduction needle. The ink is introduced into a common liquid chamber (also called a reservoir or a manifold) of the recording head through an introduction path formed inside the head. The ink introduced into the common liquid chamber is supplied to pressure chambers, which are connected to the common liquid chamber. Pressure fluctuation is generated in the pressure chambers by driving a piezoelectric vibrator or a heating element, which is an example of a pressure generating unit. By controlling the pressure fluctuation, droplets of ink are ejected from nozzles connected to the pressure chambers.

Due to a shock or the like that occurs when, for example, replacing an ink cartridge, an excessively high positive pressure or an excessively high negative pressure may be generated in a liquid flow path of the recording head. If such a pressure is transferred to a nozzle, a meniscus formed in the nozzle may break. That is, the meniscus may become excessively recessed from the inner peripheral surface of the nozzle toward the pressure chamber or may excessively bulge outward from a surface of the nozzle in which the ejection opening is formed. If the pressure at a meniscus exceeds a breakage pressure, the meniscus is not normally formed, that is, the meniscus breaks, so that ink may not be ejected and thereby so-called missing dots may occur. Moreover, ink may leak from the nozzle. To prevent such problems, a technology has been proposed with which, when a shock or a vibration having a magnitude that is larger than a predetermined threshold is applied to a printer, a pressure generating element generates a pressure in a direction such that a force applied to ink due to the shock or the vibration is cancelled out (see, for example, JP-A-2005-103818).

However, with a structure that drives a pressure generating element after a vibration or a change in pressure has been detected, it is difficult to drive the pressure generating element so as to adapt to a shock or the like, and therefore breakage of a meniscus may not be reliably prevented. Moreover, because it is difficult to detect the magnitude of a pressure that is directly applied to a meniscus, the meniscus may break undesirably or misejection may occur when the pressure generating element is driven.

Such a phenomenon occurs not only in the recording head described above, but also in other liquid ejecting heads that have a structure with which a liquid stored in a liquid storage member is introduced into the head and in liquid ejecting apparatuses that include such liquid ejecting heads.

### SUMMARY

An advantage of some aspects of the invention is that a liquid ejecting apparatus that can reliably prevent problems that may be caused by breakage of a meniscus is provided.

According to an aspect of the invention, a liquid ejecting apparatus includes a liquid storage member, a liquid ejecting head, and a detection unit. The liquid storage member stores a liquid. The liquid ejecting head introduces the liquid in the liquid storage member into a pressure chamber, generates pressure fluctuation in the liquid in the pressure chamber by operating a pressure generating unit, and ejects the liquid in the pressure chamber from a nozzle in the form of a droplet by using the pressure fluctuation. The detection unit detects a change in the relative positions of the liquid storage member and the liquid ejecting head. A meniscus restoration operation is performed on the nozzle if the change in the relative positions detected by the detection unit exceeds a threshold.

With the aspect of the invention, if the change in the relative positions detected by the detection unit exceeds a threshold, a meniscus restoration operation is performed on a nozzle. Therefore, even if a meniscus breaks due to a vibration or a shock that occurs when, for example, replacing a liquid storage member, the meniscus can be restored to a normal state (a state in which a meniscus is formed in the nozzle at an intended position and liquid can be appropriately ejected). As a result, curving of the flight path of liquid, the occurrence of missing dots, and the like, which may be caused by a problem with a meniscus, can be prevented.

It is preferable that the liquid storage member be provided in a plurality and the liquid storage members can be mounted on the liquid ejecting head, the detection unit detect the change in the relative positions for each of the liquid storage members, and the restoration operation be performed for a nozzle group corresponding to each of the liquid storage members.

In this case, even if a meniscus in a nozzle of a liquid storage member breaks due to a shock that occurs when replacing another liquid storage member, the meniscus can be restored to the normal state.

It is preferable that the meniscus restoration operation restore a meniscus by causing the liquid to be ejected by operating the pressure generating unit.

In this case, a meniscus restoration operation can be performed by using an existing structure of a liquid ejecting apparatus. Thus, it is not necessary to use an additional mechanism for restoring a meniscus.

It is preferable that the meniscus restoration operation restore a meniscus by sucking in the liquid from the nozzle.

Also in this case, a meniscus restoration operation can be performed by using an existing structure of a liquid ejecting apparatus. Thus, it is not necessary to use an additional mechanism for restoring a meniscus.

The detection unit may be a magnetic displacement sensor.

### BRIEF DESCRIPTION OF THE DRAWINGS

The invention will be described with reference to the accompanying drawings, wherein like numbers reference like elements.

FIG. 1 is a perspective view illustrating the structure of a printer.

FIG. 2 is a block diagram illustrating the electric configuration of the printer.

FIG. 3 is a schematic view illustrating the structures of an ink cartridge, a recording head, and a capping mechanism.

FIGS. 4A to 4C are schematic views illustrating a meniscus in different states.

FIG. 5 is a graph representing a change in the relative positions of an ink cartridge and a recording head.

FIG. 6 is a schematic view illustrating a structure according to a second embodiment.

### DESCRIPTION OF EXEMPLARY EMBODIMENTS

Hereinafter, embodiments according to the invention will be described with reference to the drawings. Unless otherwise noted, the scope of the invention is not limited due to the description of the embodiments described below, although the embodiments have various limitations as preferred embodiments. In the following description, an ink jet recording apparatus (hereinafter referred to as a “printer”) including an ink jet recording head (an example of a liquid ejecting head, hereinafter referred to as a “recording head”), will be used as an example of a liquid ejecting apparatus according to the invention.

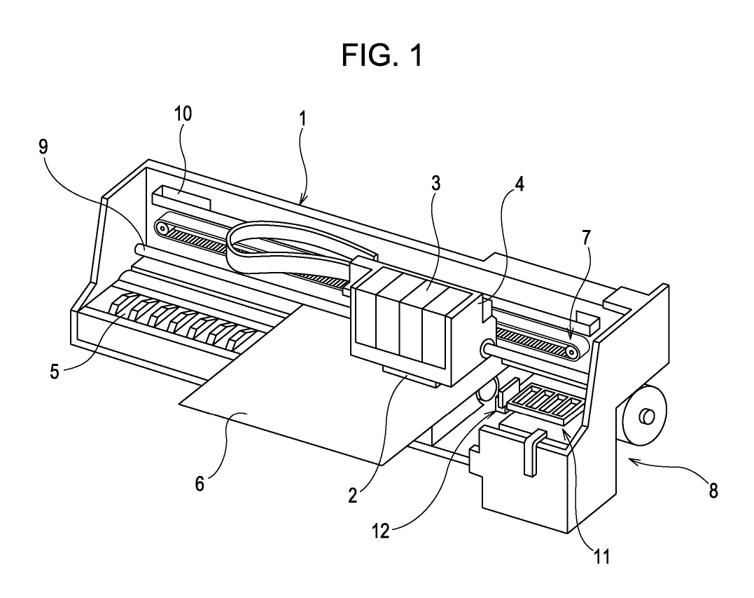

FIG. 1 is a perspective view illustrating the internal structure of a printer 1. The printer 1 includes a carriage 4, a platen 5, a carriage movement mechanism 7, and a transport mechanism 8. A recording head 2 is attached to the carriage 4; and ink cartridges 3, which are examples of a liquid storage member, are attached to the carriage 4. The platen 5 supports the back side of a recording sheet 6 (an example of a recording medium and a droplet-landing target) while recording is performed. The carriage movement mechanism 7 reciprocates the carriage 4 in the width direction of the recording sheet 6, that is, in the main scanning direction. The transport mechanism 8 transports the recording sheet 6 in the sub-scanning direction, which is perpendicular to the main scanning direction.

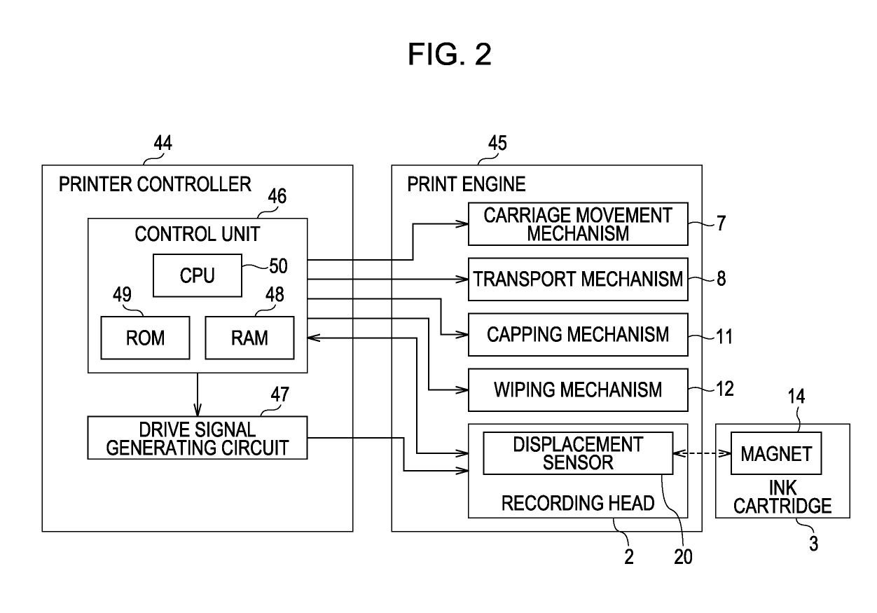

The carriage 4 is supported by a guide rod 9 extending in the main scanning direction. The carriage 4 is moved by the carriage movement mechanism 7 along the guide rod 9 in the main scanning direction. A linear encoder 10 detects the position of the carriage 4 in the main scanning direction. The linear encoder 10, which is an example of a position information output unit, outputs an encoder pulse representing the scanning position of the recording head 2 to a printer controller 44 (FIG. 2) as positional information in the main scanning direction.

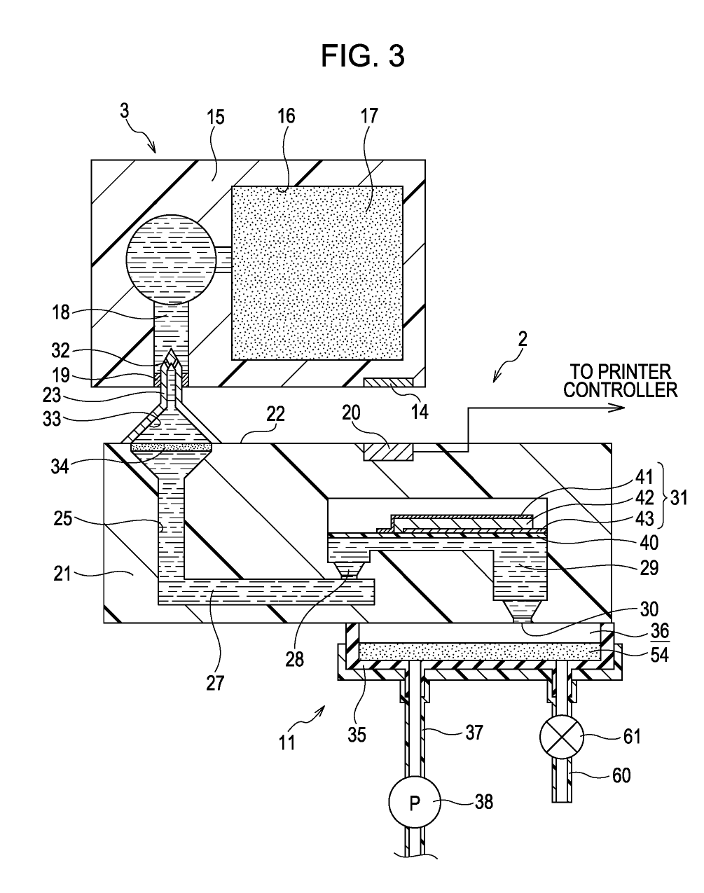

A home position, which is a base position from which the carriage 4 starts scanning, is set in an end region outside a recording region within a movement range of the carriage 4. In the present embodiment, a capping mechanism 11 for sealing a nozzle surface (see FIG. 3) of the recording head 2 and a wiping mechanism 12 for wiping the nozzle surface are disposed at the home position. The printer 1 can perform so-called two-way recording, with which the printer 1 records characters, an image, and the like on the recording sheet 6 both when the carriage 4 moves from the home position to an opposite end position and when the carriage 4 returns from the opposite end position to the home position.

FIG. 3 is a schematic sectional view illustrating the structures of one of the ink cartridges 3, the recording head 2, and the capping mechanism 11. FIG. 3 illustrates the structures for one nozzle row, which are the same as those for other nozzle rows. The ink cartridge 3 includes a box-like case 15 and a container chamber 16 formed in the case 15. The case 15 is made by, for example, molding a thermoplastic resin or the like. An ink holding member 17 is disposed in the container chamber 16. The ink holding member 17 absorbs and holds an ink, which is an example of a liquid in the invention. The ink holding member 17 is made of, for example, a sponge-like foam material. A part of a needle insertion portion 18 (an example of a connection portion between the ink cartridge 3 and the recording head 2) is formed in the bottom surface of the ink cartridge 3. An ink introduction needle 23 of the recording head 2 is inserted into the needle insertion portion 18. A packing 19 is disposed on the inner peripheral surface of an opening portion of the needle insertion portion 18. When the ink introduction needle 23 is inserted into the needle insertion portion 18, the packing 19 comes into contact with an outer peripheral surface of the ink introduction needle 23 in a liquid-tight manner and thereby prevents ink stored in the ink cartridge 3 from leaking to the outside of the ink cartridge 3. The ink cartridge 3 is provided for each type (color) of ink. In the present embodiment, the ink cartridges 3 of four types (four colors) can be mounted on the recording head 2.

On the bottom surface of the case 15 of each of the ink cartridges 3 (a surface facing the recording head 2), a magnet 14 is attached at a position at which the magnet 14 faces a displacement sensor 20 of the recording head 2 when the ink cartridge 3 is mounted on the recording head 2. Detection of a change in the relative positions of the ink cartridge 3 and the recording head 2 by using the magnet 14 will be described below. The structure of the ink cartridge 3 is not limited to the example described above, and various ink cartridges having known structures can be used.

The recording head 2 according to the present embodiment includes a head case 21, a cartridge mounting portion 22 (liquid introduction portion), the ink introduction needle 23, and the displacement sensor 20 (an example of a detection unit in the invention). The head case 21 is made of a synthetic resin. The cartridge mounting portion 22 is disposed on an upper surface of the head case 21 (a surface opposite to a nozzle surface 24, in which nozzles are formed). The ink introduction needle 23 stands on the cartridge mounting portion 22. The displacement sensor 20 is disposed in the cartridge mounting portion 22. An ink introduction path 25, a reservoir 27 (common liquid chamber), an ink supply port 28 (liquid supply port), a pressure chamber 29, an ink flow path connected to a nozzle 30, and a piezoelectric vibrator 31 are disposed in the head case 21. The piezoelectric vibrator 31 functions as a pressure generating unit.

The ink introduction needle 23 is a hollow needle-like member whose tip end portion has a tapering shape (conical shape). The ink introduction needle 23 is an example a connection portion between the recording head 2 and the ink cartridge 3. An ink introduction hole 32 for introducing ink from the ink cartridge 3 is formed in a tip end portion of the ink introduction needle 23. When the ink introduction needle 23 is inserted into the needle insertion portion 18 of the ink cartridge 3, ink stored in the cartridge is introduced into a needle flow path 33 through the ink introduction hole 32. A base end portion (an end portion opposite to the tip end portion) of the ink introduction needle 23 has a conical shape whose inside diameter (inside dimension) increases from a tip end thereof toward a base end thereof. The ink introduction needle 23 is welded to a periphery of an upstream opening of the ink introduction path 25 in the cartridge mounting portion 22 with a filter 34 therebetween. The filter 34 filters ink that has been introduced into the needle flow path 33 in the ink introduction needle 23 and supplies the ink to the ink introduction path 25.

The ink introduction path 25 is a flow path that has an inlet opening formed in the cartridge mounting portion 22 at a first end (upstream end) thereof and that is connected to the reservoir 27 at a second end thereof. The ink introduction path 25 extends in the height direction of the head case 21. A portion of the ink introduction path 25 at the first end has a conical shape whose inside diameter gradually increases toward the inlet opening. The conical portion of the ink introduction path 25 serves as, together with the conical portion of the ink introduction needle 23, a filter chamber in which the filter 34 is disposed.

Ink that has flowed downward along the ink introduction path 25 is introduced into the reservoir 27. The reservoir 27 is a common space for a plurality of pressure chambers 29 and is provided for each type of ink, that is, for each color of ink. Each pressure chamber 29 is individually connected to the reservoir 27 through the ink supply port 28. Therefore, ink in the reservoir 27 is supplied to each pressure chamber 29 through the ink supply port 28. The ink supply port 28 has a width smaller than that of the pressure chamber 29 and applies a flow resistance to ink that flows from the reservoir 27 into the pressure chamber 29. The pressure chamber 29 is an elongated chamber extending in a direction perpendicular to a direction in which rows of the nozzles 30 are arranged (nozzle row direction). A moving plate 40, which is flexible, is disposed on the upper surface of the pressure chamber 29. The piezoelectric vibrator 31 is disposed on a side of the moving plate 40 opposite to a side on which the pressure chamber 29 is disposed. The piezoelectric vibrator 31 is, for example, a so-called deflection-vibration-mode piezoelectric vibrator. The piezoelectric vibrator 31 includes a drive electrode 41, a common electrode 43, and a piezoelectric member 42 sandwiched between the electrodes 41 and 43. When a drive voltage (drive pulse) is applied to the drive electrode 41 of the piezoelectric vibrator 31, an electric field corresponding to the potential difference is generated between the drive electrode 41 and the common electrode 43. The electric field is applied to the piezoelectric member 42, and the piezoelectric member 42 becomes deformed in accordance with the strength of the electric field. That is, when a voltage applied to the drive electrode 41 is increased, a middle portion of the piezoelectric member 42 becomes deformed in a direction toward the inside of the pressure chamber 29 (toward the nozzle 30) and deforms the moving plate 40 so that the volume of the pressure chamber 29 is reduced. When the voltage applied to the drive electrode 41 is reduced (to become closer to 0), the middle portion of the piezoelectric member 42 deflects toward the outside of the pressure chamber 29 (in a direction away from the nozzle) and deforms the moving plate 40 so that the volume of the pressure chamber 29 is increased. Instead of the piezoelectric vibrator, an electrostatic actuator, a magnetostrictor, a heating element, or the like can be used as a pressure generating unit.

A nozzle row (nozzle group), in which the nozzles 30 are arranged, is formed in the nozzle surface 24. According to the present embodiment, the nozzle row is provided for each type of ink, that is, each color of ink. Four nozzle rows are formed in the nozzle surface 24 so as to correspond to the ink cartridges 3 for the four colors. Alternatively, one nozzle row may be used for two or more types of ink.

By driving the piezoelectric vibrator 31 as described above, the volume of the pressure chamber 29 can be changed. Thus, pressure fluctuation occurs in ink in the pressure chamber 29, and the ink can be ejected from the nozzle 30 by using the pressure fluctuation. For example, when the pressure chamber 29 is expanded by charging the piezoelectric vibrator 31 and then the pressure chamber 29 is contracted by discharging the piezoelectric vibrator 31, ink that has flowed into the pressure chamber 29 when the pressure chamber 29 expanded is pressurized rapidly, and thereby an ink droplet is ejected from the nozzle 30.

According to the invention, the recording head 2 includes the displacement sensor 20 that detects a change in the relative positions of the recording head 2 and the ink cartridge 3. The displacement sensor 20 is, for example, a magnetic displacement sensor including a magnetoresistive element. The displacement sensor 20 detects a change in the magnetic field of the magnet 14 of the ink cartridge 3 and outputs a detection signal, which is a signal representing a change in the relative positions, to the printer controller 44. That is, the displacement sensor 20 detects a change in the relative positions of the ink cartridge 3 and the recording head 2 that occurs if a vibration or a shock is applied to the ink cartridge 3 and the recording head 2 when, for example, replacing the ink cartridge 3.

The capping mechanism 11 includes a tray-like cap member 35, a cap movement mechanism (not shown), an elastic drain tube 37, and a pump 38. The cap movement mechanism moves the cap member 35 in directions in which the cap member 35 moves toward or away from the nozzle surface of the recording head 2. The drain tube 37 connects an inner space of the cap member 35 to a drain tank (not shown). The pump 38 is disposed in a part of the drain tube 37.

The cap member 35 is a tray-like member having an upper opening. A space in the cap member 35 is a sealing space 36. The cap member 35 is made of an elastic material such as a rubber or the like. The cap member 35 forms the sealing space 36 independently for each type (color) of ink (see FIG. 1). That is, the cap member 35 can cap a nozzle row corresponding to an ink contained in each of the ink cartridges 3. A liquid absorbent member 54 is disposed on a bottom portion of each sealing space 36. The liquid absorbent member 54 is made of a liquid absorbent material that can absorb ink, such as felt or sponge. A through-hole is formed in a bottom portion of the cap member 35, and the drain tube 37 is connected to the through-hole. Another through-hole is formed in a bottom portion of the cap member 35, and an air vent tube 60, which forms an air vent path, is connected to the through-hole. An air vent valve 61 is disposed in a part of the air vent tube 60. By operating the air vent valve 61, the state of the sealing space 36 in a sealed state in which the nozzle surface is sealed can be switched between a tightly closed state and an air vent state.

In the sealed state, the nozzle surface 24 of the recording head 2 is sealed with the cap member 35. In this state, the nozzle 30 in the nozzle surface 24 faces the sealing space 36 and the tip end of the cap member 35 is in contact with the nozzle surface 24 in a liquid-tight manner. By closing the air vent valve 61 and operating the pump 38 in the sealed state, the pressure in the sealing space 36 is reduced. As a result, ink, bubbles, and the like in the recording head 2 can be sucked in through the nozzle 30 and discharged to the outside of the head. This suction control is used for an initial filling operation and for a cleaning operation. The initial filling operation is an operation of filling the ink flow path of the recording head 2 with ink when the ink cartridge 3 is mounted. The cleaning operation is an operation of removing thickened ink and bubbles in the ink flow path. In the printer 1 according to the invention, the suction control is also performed for a meniscus restoration operation performed on the nozzle 30.

FIG. 2 is a block diagram illustrating the electric configuration of the printer 1. The printer 1 according to the present embodiment includes the printer controller 44 and a print engine 45. The printer controller 44 includes a control unit 46 and a drive signal generation circuit 47 (an example of a drive signal generation unit). The control unit 46 includes a RAM 48 that stores various data items and the like, a ROM 49 that stores a control program and the like for performing various control operations, and a CPU 50 that performs overall control of various units on the basis of the control program stored in the ROM 49. The drive signal generation circuit 47 generates a drive signal that is supplied to the recording head 2. The print engine 45 includes the recording head 2, the carriage movement mechanism 7, the transport mechanism 8, the capping mechanism 11, the wiping mechanism, and the like.

The printer 1 performs a meniscus restoration operation when a change in the relative positions of the ink cartridge 3 and the recording head 2, which is detected by the displacement sensor 20, exceeds a predetermined threshold. This point will be described in detail below.

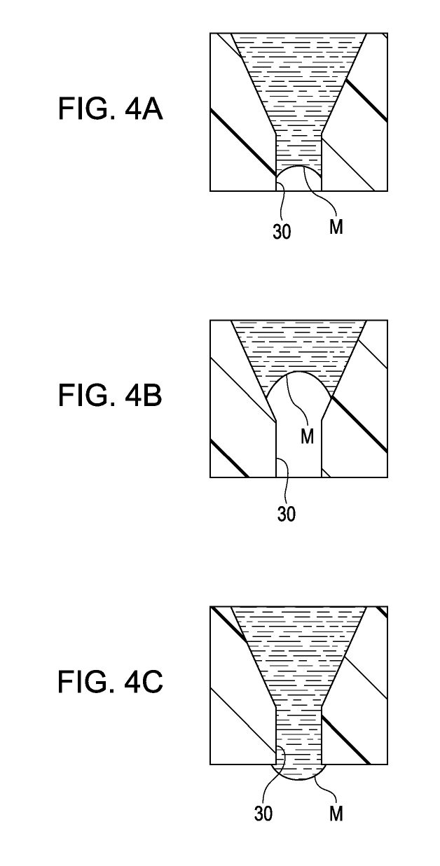

FIGS. 4A to 4C are schematic views illustrating a meniscus in different states. An excessively high positive pressure or an excessively high negative pressure may be generated in the ink flow path of the recording head 2 due to a vibration, a shock, or the like that occurs when replacing the ink cartridge 3, when opening/closing a body cover of the printer 1, or when opening/closing an auto document feeder (ADF). If such a pressure is transferred to the nozzle 30, a meniscus formed in the nozzle 30 may break. FIG. 4A illustrates a meniscus M in a normal state, in which the meniscus M is formed in a straight portion of the nozzle 30, the inside diameter of which is constant, at a position slightly recessed from a surface in which an ejection opening is formed. In this state, ink can be appropriately ejected. However, if the aforementioned pressure generated due to a shock or the like is applied to the meniscus M, the meniscus M may become excessively recessed from the inner peripheral surface of the straight portion of the nozzle 30 toward the pressure chamber 29 (FIG. 4B) or may excessively bulge outward from the surface of the nozzle 30 in which the ejection opening is formed (FIG. 4C). If ink is ejected in such a state, the amount of ejected ink may be smaller than intended or the flight path of ejected ink may be curved, so that the ink may not be appropriately ejected. If the pressure applied to the meniscus M due to a shock or the like exceeds the breakage pressure of the meniscus M, the meniscus M is not appropriately formed, that is, the meniscus M breaks, so that ink may not be ejected and so-called missing dots may occur. Moreover, ink may leak from the nozzle 30.

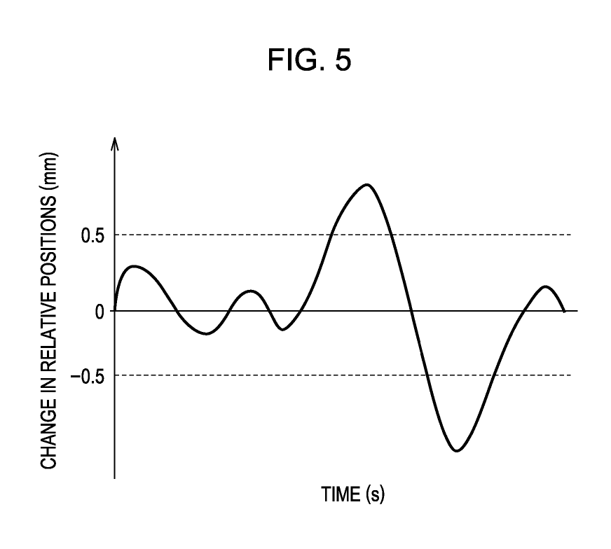

FIG. 5 is a graph representing a change in the relative positions of the ink cartridge 3 and the recording head 2. In the graph, the horizontal axis represents time (s) and the vertical axis represents a change in the relative positions (mm). A value of zero on the vertical axis corresponds to the relative positions in a normal state (in which a change in the relative positions due to a vibration, a shock, or another external force is not occurring). The larger the positive value of the change in the relative positions, the farther the ink cartridge 3 and the recording head 2 are from each other. The larger the negative value of the change, the closer the ink cartridge 3 and the recording head 2 are to each other.

There is a correlation between the change in the relative positions of the ink cartridge 3 and the recording head 2 and the pressure fluctuation in the ink flow path. The pressure applied to the meniscus changes in accordance with the change in the relative positions of the ink cartridge 3 and the recording head 2. If the change in the relative positions exceeds a predetermined value, the pressure exceeds the breakage pressure and the meniscus breaks. To prevent this, the printer 1 according to the invention performs a meniscus restoration operation when the change in the relative positions of the ink cartridge 3 and the recording head 2 exceeds a predetermined threshold. The threshold corresponds to a change in the relative positions at which the meniscus is likely to break. The threshold can be appropriately set in accordance with the specifications of the recording head 2, the ink, and the like. In the present embodiment, the threshold is a value of a detection signal of the displacement sensor 20 corresponding to a change in the relative positions at which the meniscus is likely to break. For example, the values of the detection signal corresponding to the change in relative positions of ±0.5 mm are set as the threshold.

A meniscus restoration operation is performed for each ink cartridge 3 as described below. That is, the printer controller 44 monitors the detection signal sent from the displacement sensor 20, which is provided for each ink cartridge 3. If it is determined that the change in the relative positions of one of the ink cartridges 3 and the recording head 2 exceeds the aforementioned threshold, the printer controller 44 controls the carriage movement mechanism 7 so as to move the carriage 4 to the home position and causes the capping mechanism 11 to cap the nozzle surface of the recording head 2. At this time, the sealing space 36 corresponding to a nozzle row to be subjected to a meniscus restoration operation is tightly closed (in a liquid tight or air tight manner) by closing the air vent valve 61. Next, the printer controller 44 starts driving the pump 38 while the nozzle surface is capped as described above and starts a suction operation. Because the suction operation is performed in order to restore a broken meniscus to a normal state in which ink can be ejected, the amount of suction is set smaller than that of a cleaning operation or an initial filling operation. Due to the suction operation, the broken meniscus is restored to the normal state illustrated in FIG. 4A. That is, the printer controller 44 and the capping mechanism 11 perform a meniscus restoration operation according to the invention. Thus, even if a meniscus breaks due to a vibration or a shock that occurs when, for example, replacing the ink cartridge 3, the meniscus can be restored to the normal state. As a result, problems such as curving of the flight path of ink and the occurrence of missing dots can be prevented.

With the present embodiment, the displacement sensor 20 and the magnet 14 are provided for each ink cartridge 3, a change in the relative positions is monitored for each ink cartridge 3, and the meniscus restoration operation is performed for each ink cartridge 3. Therefore, even if a meniscus in a nozzle of one of the ink cartridges 3 breaks due to a shock when replacing another ink cartridge 3, the meniscus can be restored to the normal state. With existing structures, capping and suction operations can be performed on each nozzle corresponding to each ink cartridge. However, with existing structures, although capping and suction operations are performed on a nozzle row of a new ink cartridge after replacement, a suction operation is not performed on a nozzle row of another ink cartridge that has not been replaced. Therefore, there is a problem in that, due to a shock that occurs when, for example, replacing an ink cartridge, a meniscus in a nozzle of another ink cartridge may break and problems such as the occurrence of missing dots may occur. In contrast, the printer 1 according to the invention can restore the meniscus to the normal state even in such cases and can prevent problems such as the occurrence of missing dots.

The invention is not limited to the embodiment described above, and can be modified in various ways in accordance with the description in the claims.

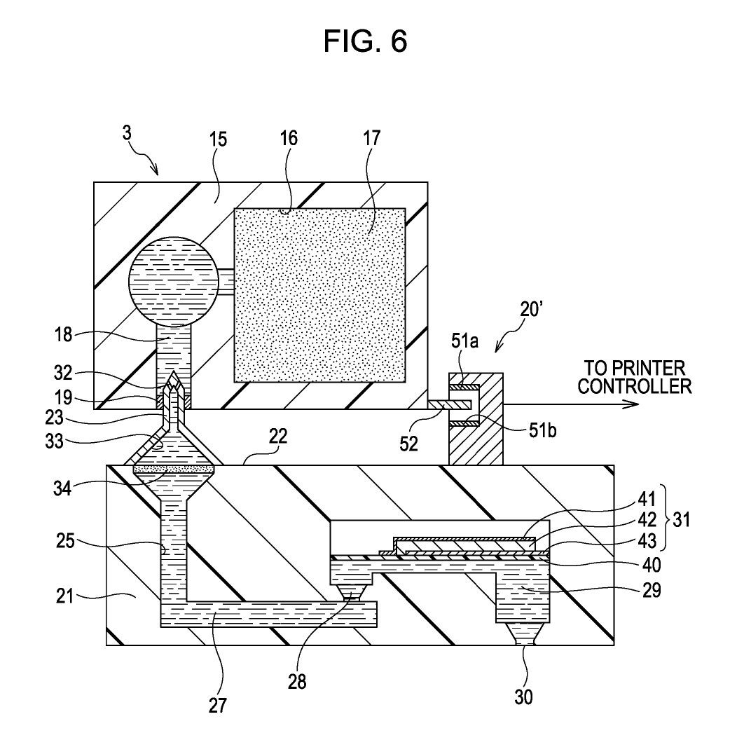

For example, in the embodiment described above, a magnetic displacement sensor is used as the displacement sensor 20. However, this is not necessarily the case. For example, FIG. 6 illustrates a second embodiment, in which a contact sensor is used as a displacement sensor 20′. The displacement sensor 20′ includes a pair of upper and lower electrode plates 51a and 51b, between which a detector 52, which is a metal piece disposed on the ink cartridge 3, can be inserted without contacting the electrode plates 51a and 51b. When the relative positions of the ink cartridge 3 and the recording head 2 are normal (when a change due to a vibration, a shock, or the like is not occurring), the detector 52 is located at a neutral position at which the detector 52 is separated from the upper and lower electrode plates 51a and 51b by substantially the same distance. When the relative positions of the ink cartridge 3 and the recording head 2 changes, the detector 52 moves vertically between the electrode plates. If the relative positions of the ink cartridge 3 and the recording head 2 change more than a predetermined amount, the detector 52 comes into contact with one of the electrode plates. The displacement sensor 20′ detects the state of contact and outputs a detection signal to the printer controller 44. Therefore, with this structure, the distances from the detector 52 to the upper and lower electrode plates correspond to the threshold. As a further alternative, various displacement sensors that can detect the change in the relative positions of the ink cartridge 3 and the recording head 2 can be used as the displacement sensor. Examples of such sensors include an optical displacement sensor, which detects the change in the relative positions by using a laser beam, and a capacitance displacement sensor, which detects the change in the relative positions on the basis of a change in capacitance.

In the embodiments described above, a change in the relative positions may be, for example, a relative displacement between the ink cartridge 3 and the recording head 2 or may be a change in the relative positions per unit time.

In the embodiments described above, suction control is performed as a restoration operation. Alternatively, liquid may be drained by, for example, driving a pressure generating unit.

In the embodiments described above, the ink introduction needle 23 of the recording head 2 is inserted into the needle insertion portion 18 of the ink cartridge 3, and thereby ink stored in the ink cartridge 3 is introduced into the flow path in the recording head 2. Alternatively, the invention can be applied to a structure that does not include the ink introduction needle 23. For example, ink may be introduced into the flow path by disposing an ink absorber in the connection portion of the ink cartridge so as to be in contact with a filter disposed in the connection portion of the recording head.

In addition to the recording head 2, the invention can be applied to any liquid ejecting heads having a structure with which a liquid is introduced into the recording head from a liquid storage member. Such liquid ejecting heads can be used in various ink jet recording apparatuses such as a plotter, a facsimile machine, a copier, and the like; and in liquid ejecting apparatuses other than recording apparatuses, such as display manufacturing apparatuses, electrode forming apparatuses, chip manufacturing apparatuses, and the like. Display manufacturing apparatuses have a colorant ejecting head that ejects a solution of red (R), green (G), and blue (B) colorants. Electrode forming apparatuses have an electrode material ejecting head that ejects a liquid electrode material. Chip manufacturing apparatuses have a bioorganic substance ejecting head that ejects a solution of a bioorganic substance.

What is claimed is:

1. A liquid ejecting apparatus comprising:
a liquid storage member that stores a liquid;
a liquid ejecting head that introduces the liquid in the liquid storage member into a pressure chamber, generates pressure fluctuation in the liquid in the pressure chamber by operating a pressure generating unit, and ejects the liquid in the pressure chamber from a nozzle in the form of a droplet by using the pressure fluctuation; and
a detection unit that detects a change in the relative positions of the liquid storage member and the liquid ejecting head,
wherein a meniscus restoration operation is performed on the nozzle if the change in the relative positions detected by the detection unit exceeds a threshold.

2. The liquid ejecting apparatus according to claim 1,
wherein the liquid storage member is provided in a plurality and the liquid storage members can be mounted on the liquid ejecting head,
wherein the detection unit detects the change in the relative positions for each of the liquid storage members, and
wherein the restoration operation is performed for a nozzle group corresponding to each of the liquid storage members.

3. The liquid ejecting apparatus according to claim 1,
wherein the meniscus restoration operation restores a meniscus by causing the liquid to be ejected by operating the pressure generating unit.

4. The liquid ejecting apparatus according to claim 1,
wherein the meniscus restoration operation restores a meniscus by sucking in the liquid from the nozzle.

5. The liquid ejecting apparatus according to claim 1,
wherein the detection unit is a magnetic displacement sensor.
